(19) United States
(12) Patent Application Publication
(10) Pub. No.: US 2024/0417873 A1
(43) Pub. Date: Dec. 19, 2024

(54) POROUS BASE LAYER AND ELECTROCHEMICAL DEVICE

(71) Applicants: Hyundai Motor Company, Seoul (KR); Kia Corporation, Seoul (KR)

(72) Inventor: Young June PARK, Yangseo-Myeon (KR)

(73) Assignees: Hyundai Motor Company, Seoul (KR); Kia Corporation, Seoul (KR)

(21) Appl. No.: 18/370,282

(22) Filed: Sep. 19, 2023

(30) Foreign Application Priority Data
Jun. 14, 2023 (KR) 10-2023-0076321

(51) Int. Cl. C25B 13/02; C25B 9/23

(52) U.S. Cl. CPC C25B 13/02; C25B 9/23; H01M 8/0258; H01M 8/1004

(57) ABSTRACT

A porous base layer includes a porous base portion provided between a membrane electrode assembly (MEA) and a separator including a channel and a land, a channel area defined on the porous base portion to correspond to the channel, a land area defined on the porous base portion to correspond to the land and provided to be in contact with the land, and at least one through-hole provided in the land area so that a target fluid passes through the through-holes, obtaining an advantageous effect of ensuring performance and operational efficiency and improving durability and reliability.

### CROSS-REFERENCE TO RELATED APPLICATION

The present application claims priority to Korean Patent Application No. 10-2023-0076321 on Jun. 14, 2023, the entire contents of which is incorporated herein for all purposes by this reference.

### BACKGROUND OF THE PRESENT DISCLOSURE

### Field of the Present Disclosure

The present disclosure relates to a porous base layer and an electrochemical device, and more particularly, to a porous base layer capable of ensuring performance and operational efficiency and improving durability and reliability.

### DESCRIPTION OF RELATED ART

There is a consistently increasing demand for research and development on alternative energy to cope with global warming and depletion of fossil fuel. Hydrogen energy is attracting attention as a practical solution for solving environment and energy issues.

Because hydrogen has high energy density and properties suitable for application in a grid-scale, hydrogen is in the limelight as a future energy carrier.

A water electrolysis stack, which is one of electrochemical devices, refers to a device that produces hydrogen and oxygen by electrochemically decomposing water. The water electrolysis stack may be configured by stacking several tens or several hundreds of water electrolysis cells (unit cells) in series.

A membrane-electrode assembly (MEA) is positioned at an innermost side of the unit cell of the water electrolysis stack. The membrane-electrode assembly includes a perfluorinated sulfonic acid ionomer-based electrolyte membrane configured for moving hydrogen ions (protons), and an anode electrode and a cathode electrode respectively disposed on two opposite surfaces of the electrolyte membrane.

Furthermore, a porous transport layer (PTL), a gas diffusion layer (GDL), and a gasket may be stacked on each of the external portions (external surfaces) of the membrane-electrode assembly (MEA) on which the anode and the cathode are positioned. A separator (or bipolar plate) may be disposed on an external side (external surface) of the porous transport layer (PTL) and the gas diffusion layer (GDL). The separator includes flow paths (flow fields) through which a reactant, a coolant, and a product produced by a reaction flow, or the separator may include a structure which may be substituted for the flow paths.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a porous base layer and an electrochemical device, which are configured for ensuring performance and operational efficiency and improving durability and reliability.

The present disclosure has also been made in an effort to effectively diffuse a target fluid and uniformly supply the target fluid to an entire region of a membrane electrode assembly.

Among other things, the present disclosure has been made in an effort to effectively supply the target fluid to a land area of a porous base layer provided to be in contact with a land of a separator.

The present disclosure has also been made in an effort to improve transmittance of the porous base layer and improve efficiency in moving the target fluid (performance in transmitting the target fluid).

The present disclosure has also been made in an effort to improve stability, reliability, and durability.

The objects to be achieved by the exemplary embodiments are not limited to the above-mentioned objects, but also include objects or effects which may be understood from the solutions or embodiments described below.

An exemplary embodiment of the present disclosure provides a porous base layer including: a porous base portion provided between a membrane electrode assembly (MEA) and a separator including a channel and a land: a channel area defined on the porous base portion to correspond to the channel; a land area defined on the porous base portion to correspond to the land and provided to be in contact with the land; and at least one through-hole provided in the land area so that a target fluid passes through the through-holes.

According to the exemplary embodiment of the present disclosure, a porosity of the land area may be defined to increase in a direction from an inlet portion to an outlet portion of the channel in a longitudinal direction of the channel.

According to the exemplary embodiment of the present disclosure, the through-holes may include: a first through-hole; and a second through-hole defined to include a size different from a size of the first through-hole and spaced from the first through-hole in a longitudinal direction of the channel.

According to the exemplary embodiment of the present disclosure, the through-holes may include: a first through-hole; and a second through-hole provided at a downstream side from the first through-hole in a longitudinal direction of the channel and defined to include a relatively larger cross-sectional area than the first through-hole.

According to the exemplary embodiment of the present disclosure, the through-hole may be defined to include a cross-sectional area that gradually increases in a direction from an inlet end portion to an outlet end portion of the channel in a longitudinal direction of the channel.

According to the exemplary embodiment of the present disclosure, the porous base portion may be defined to include a pore of 9 to 16 μm.

According to the exemplary embodiment of the present disclosure, the through-hole may be defined to include a diameter of 20 to 50 μm.

According to the exemplary embodiment of the present disclosure, the channel area may be defined to include a predetermined reference porosity, and the land area including the through-hole may be defined to include a porosity of 120 to 200% of the reference porosity.

Another exemplary embodiment of the present disclosure provides an electrochemical device including: a membrane electrode assembly (MEA): a separator including a channel and a land provided on one surface facing the membrane electrode assembly, the separator being stacked on the membrane electrode assembly; and a porous base layer provided between the separator and the membrane electrode assembly, in which the porous base layer includes: a porous base portion provided between the separator and the membrane electrode assembly (MEA); a channel area defined on the porous base portion to correspond to the channel; a land area defined on the porous base portion to correspond to the land and provided to be in contact with the land; and at least one through-hole provided in the land area so that a target fluid passes through the through-holes.

According to the exemplary embodiment of the present disclosure, a porosity of the land area may be defined to increase in a direction from an inlet portion to an outlet portion of the channel in a longitudinal direction of the channel.

According to the exemplary embodiment of the present disclosure, the through-holes may include: a first through-hole; and a second through-hole defined to include a size different from a size of the first through-hole and spaced from the first through-hole in a longitudinal direction of the channel.

According to the exemplary embodiment of the present disclosure, the through-holes may include: a first through-hole; and a second through-hole provided at a downstream side from the first through-hole in a longitudinal direction of the channel and defined to include a relatively larger cross-sectional area than the first through-hole.

According to the exemplary embodiment of the present disclosure, the plurality of through-holes may each be defined to include a cross-sectional area that gradually increases in a direction from an inlet end portion to an outlet end portion of the channel in a longitudinal direction of the channel.

According to the exemplary embodiment of the present disclosure, the porous base portion may be defined to include a pore of 9 to 16 μm.

According to the exemplary embodiment of the present disclosure, the through-hole may be defined to include a diameter of 20 to 50 μm.

According to the exemplary embodiment of the present disclosure, the channel area may be defined to include a predetermined reference porosity, and the land area including the through-hole may be defined to include a porosity of 120 to 200% of the reference porosity.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view for explaining an electrochemical device according to an exemplary embodiment of the present disclosure.

FIG. 2 is a view for explaining a porous base layer of the electrochemical device according to the exemplary embodiment of the present disclosure.

FIG. 3 is a view for explaining a process of manufacturing the porous base layer of the electrochemical device according to the exemplary embodiment of the present disclosure.

FIG. 4 and FIG. 5 are views for explaining a forming roller used for the process of manufacturing the porous base layer of the electrochemical device according to the exemplary embodiment of the present disclosure.

FIG. 6, FIG. 7, FIG. 8, and FIG. 9 are views for explaining a modified example of the porous base layer of the electrochemical device according to the exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to various exemplary embodiments described herein but may be implemented in various different forms. At least one of the constituent elements in the exemplary embodiments of the present disclosure may be selectively combined and substituted for use within the scope of the technical spirit of the present disclosure.

Furthermore, unless otherwise specifically and explicitly defined and stated, the terms (including technical and scientific terms) used in the exemplary embodiments of the present disclosure may be construed as the meaning which may be commonly understood by the person with ordinary skill in the art to which the present disclosure pertains. The meanings of the commonly used terms such as the terms defined in dictionaries may be interpreted based on the contextual meanings of the related technology.

Furthermore, the terms used in the exemplary embodiments of the present disclosure are for explaining the embodiments, not for limiting the present disclosure.

In the present specification, unless stated otherwise, a singular form may also include a plural form. The expression “at least one (or one or more) of A, B, and C” may include one or more of all combinations that may be made by combining A, B, and C.

Furthermore, the terms such as first, second, A, B, (a), and (b) may be used to describe constituent elements of the exemplary embodiments of the present disclosure.

These terms are used only for discriminating one constituent element from another constituent element, and the nature, the sequences, or the orders of the constituent elements are not limited by the terms.

Furthermore, when one constituent element is referred to as being ‘connected’, ‘coupled’, or ‘attached’ to another constituent element, one constituent element may be connected, coupled, or attached directly to another constituent element or connected, coupled, or attached to another constituent element through yet another constituent element interposed therebetween.

Furthermore, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

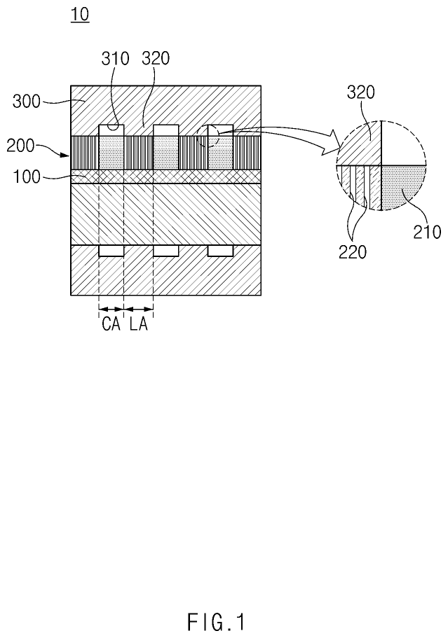

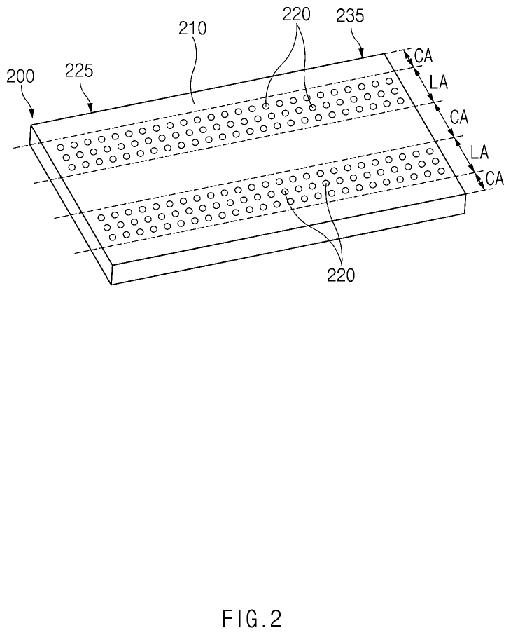

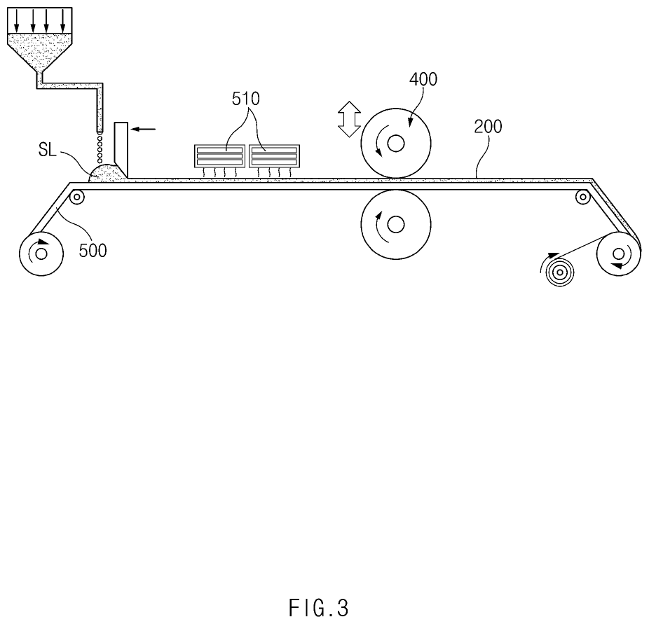

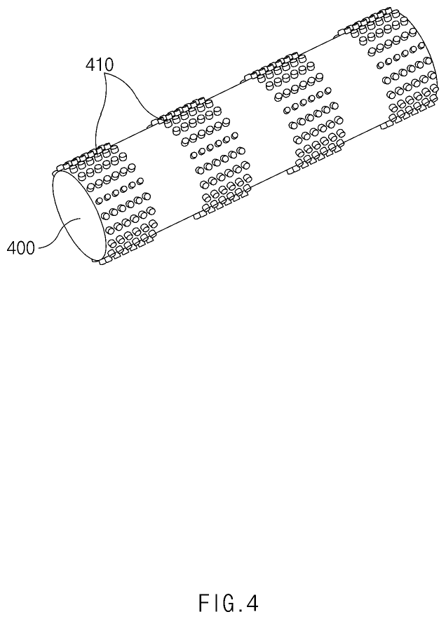

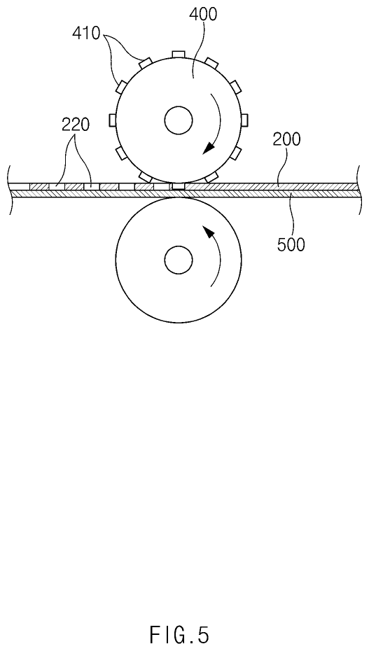

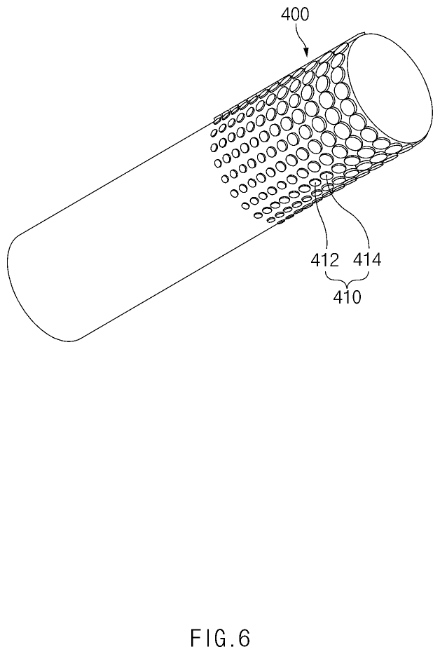

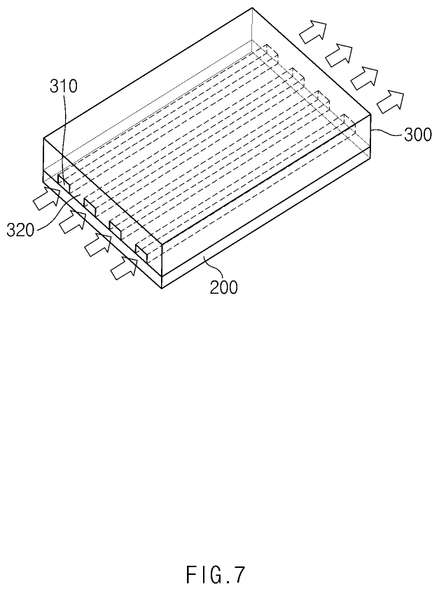

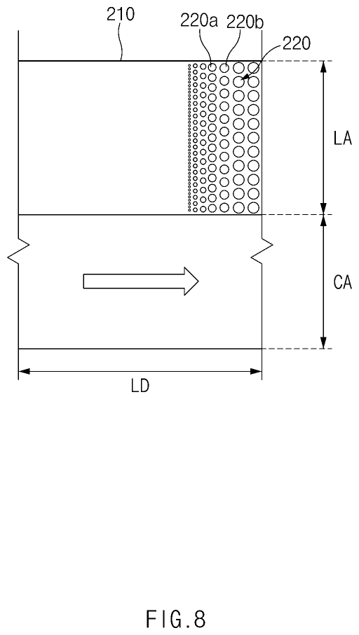

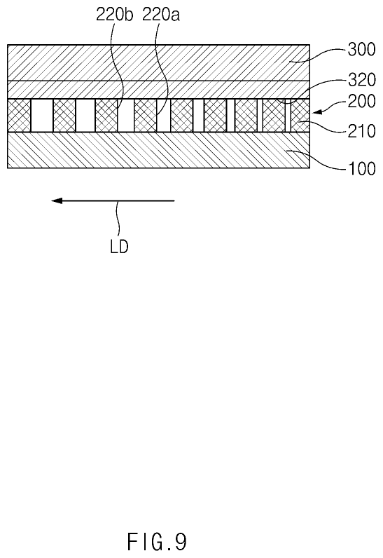

With reference to FIG. 1, FIG. 2, FIG. 3, FIG. 4, FIG. 5, FIG. 6, FIG. 7, FIG. 8 and FIG. 9, a porous base layer 200 according to an exemplary embodiment of the present disclosure includes a porous base portion 210 provided between a membrane electrode assembly (MEA) 100 and a separator 300 including channels 310 and lands 320, channel areas CA defined on the porous base portion 210 to correspond to the channels 310, land areas LA defined on the porous base portion 210 to correspond to the lands 320 and provided to be in contact with the lands 320, and through-holes 220 provided in the land areas LA so that a target fluid may pass through the through-holes 220.

For reference, the porous base layer 200 according to the exemplary embodiment of the present disclosure, together with the membrane electrode assembly (MEA) 100, may form an electrochemical device 10.

In the instant case, the electrochemical device 10 is defined as including both a water electrolysis stack configured to produce hydrogen and oxygen by electrochemically decomposing water and a fuel cell stack configured to generate electrical energy through a chemical reaction of fuel (e.g., hydrogen).

Hereinafter, an example will be described in which the electrochemical device 10 according to the exemplary embodiment of the present disclosure is used as the water electrolysis stack that produces hydrogen and oxygen by decomposing water through an electrochemical reaction.

This is to ensure performance and operational efficiency of the electrochemical device 10 and improve stability and reliability of the electrochemical device 10.

That is, the performance and output of the electrochemical device is determined depending on a transfer flow rate of the target fluid (e.g., water) to be transferred to the membrane electrode assembly 100. Therefore, it is necessary to ensure a sufficient transfer flow rate of the target fluid to be transferred to the membrane electrode assembly 100 to improve the performance and output of the electrochemical device. Furthermore, it is necessary to uniformly disperse (diffuse) the target fluid over the entire section of the membrane electrode assembly 100.

However, in the related art, because of structural characteristics of the separator including the concave channels, through which a reactant gas flows, and the convex lands provided to be in contact with the porous base layer, the channel areas of the porous base layer corresponding to the channels may sufficiently ensure a transfer flow rate (transfer efficiency) of a target fluid which is to be transferred to the membrane electrode assembly. However, it is difficult for the land areas of the porous base layer, which are in contact with the lands, to sufficiently ensure the transfer flow rate (transfer efficiency) of the target fluid to be transferred to the membrane electrode assembly. For the present reason, there is a problem in that it is difficult to implement the stable performance of the electrochemical device and improve the output.

Moreover, in the related art, there is a problem in that it is difficult to uniformly supply the target fluid to the entire region (the channel area and the land area) of the porous base layer, which degrades the durability of the membrane electrode assembly and the porous base layer.

In contrast, in the exemplary embodiment of the present disclosure, the through-hole 220, through which the target fluid may pass, may be provided in the land area LA of the porous base portion 210 with which the land 320 of the separator 300 is in contact. Therefore, it is possible to obtain an advantageous effect of sufficiently ensuring the transfer flow rate (transfer efficiency) of the target fluid to be transferred to the membrane electrode assembly 100 not only in the channel area CA of the porous base layer 200 corresponding to the channel 310, but also in the land area LA of the porous base layer 200 with which the land 320 is in contact.

Moreover, according to the exemplary embodiment of the present disclosure, the target fluid may be sufficiently supplied to the land area LA of the porous base portion 210 through the through-hole 220. Therefore, it is possible to obtain an advantageous effect of minimizing the occurrence of a dead zone in which the target fluid cannot be supplied to a particular site of the membrane electrode assembly 100 and an advantageous effect of improving the durability of the membrane electrode assembly 100 and the porous base layer 200.

Furthermore, according to the exemplary embodiment of the present disclosure, the through-holes 220 are provided in the porous base layer 200 provided to be in contact with the membrane electrode assembly 100 so that the porosity of the porous base layer 200 may be improved. Therefore, it is possible to improve the transmittance of the target fluid with respect to the porous base layer 200. Furthermore, it is possible to shorten a movement route for the target fluid passing through the porous base layer 200 by reducing the tortuosity in a thickness direction of the porous base layer 200 (an actual movement route compared to a shortest straight route in which the target fluid passes).

The water electrolysis stack (electrochemical device) may be provided by stacking a plurality of unit cells in a reference stacking direction thereof.

The unit cell may include a reaction layer and the separators 300 respectively stacked on one surface and the other surface of the reaction layer. The water electrolysis stack may be configured by stacking the plurality of unit cells in the reference stacking direction and then assembling endplates to the two opposite end portions of the plurality of unit cells.

The reaction layer may have various structures configured for generating the electrochemical reaction of a target fluid (e.g., water). The present disclosure is not restricted or limited by the type and structure of the reaction layer.

For example, the reaction layer may include the membrane electrode assembly (MEA) 100, and the porous base layers 200 provided to be in close contact with two opposite surfaces of the membrane electrode assembly 100.

The membrane electrode assembly 100 may be variously changed in structure and material in accordance with required conditions and design specifications, and the present disclosure is not limited or restricted by the structure and material of the membrane electrode assembly 100.

For example, the membrane electrode assembly 100 may be configured by attaching catalyst electrode layers (e.g., an anode layer and a cathode layer), in which electrochemical reactions are generated, to two opposite surfaces of an electrolyte membrane (e.g., a perfluorinated sulfonic acid ionomer-based electrolyte membrane).

For reference, water supplied to the anode layer, which is an oxidation electrode for the water electrolysis, is separated into hydrogen ions (protons), electrons, and oxygen. Accordingly, the hydrogen ions move to the cathode layer, which is a reduction electrode, through the electrolyte membrane, and the electrons move to a cathode through an external circuit. Furthermore, oxygen gas may be discharged to an anode outlet, and hydrogen ions and electrons may be converted into hydrogen gas at a cathode and then discharged to a cathode outlet.

The separators 300, together with the reaction layer (membrane electrode assembly), may form a single unit cell (water electrolysis cell). The separators 300 is configured to separate and block water (or water and oxygen) at the anode side and hydrogen produced at the cathode side by the reaction layer. The separators 300 may also be configured to ensure a flow path (flow field) of the fluid.

Furthermore, the separators 300 may also be configured to distribute heat, which is generated from the unit cell, to the entire unit cell, and the excessively generated heat may be discharged to the outside by water flowing along the separators 300.

For reference, in the exemplary embodiment of the present disclosure, the separators 300 are defined as including both an anode separator 300 and a cathode separator 300 that independently define the flow paths (channels) for water (or water and oxygen) and the flow paths (channels) for hydrogen in the water electrolysis stack.

For example, the separator 300 (anode separator), which faces one surface of the membrane electrode assembly 100, may define a flow path (channel) for water (or water and oxygen). The separator 300 (cathode separator), which faces the other surface of the membrane electrode assembly 100, may define a flow path (channel) for hydrogen.

The separator 300 may be stacked on the membrane electrode assembly 100. Channels 310, through which the target fluid (hydrogen or water) flows, may be provided in one surface of the separator 300 that faces the membrane electrode assembly 100. Lands 320, which are in contact with the porous base layer 200, may be provided on one surface of the separator 300 that faces the membrane electrode assembly 100. Cooling channels, through which a coolant flows, may be provided in the other surface of the separator 300.

According to the exemplary embodiment of the present disclosure, at least one of the land 320 and the channel 310 may be defined in a straight shape. Hereinafter, an example will be described in which both the land 320 and the channel 310 are each defined in a straight shape.

According to another exemplary embodiment of the present disclosure, at least any one of the land and the channel may be defined in a curved shape (e.g., a circular arc shape). Alternatively, at least any one of the land and the channel may be provided to include a structure with a combination of the straight shape and the curved shape.

The separator 300 may have various structures and be made of various materials in accordance with required conditions and design specifications. The present disclosure is not restricted or limited by the structure and material of the separator 300.

For example, the separator 300 may include an approximately quadrangular plate shape and be made of metal (e.g., titanium, stainless steel, Inconel, or aluminum).

According to another exemplary embodiment of the present disclosure, the separator may be provided in a shape of a circle or other shapes. The separator may be made of other materials such as graphite or a carbon composite.

With reference to FIG. 1 and FIG. 2, the porous base layer 200 is provided between the membrane electrode assembly 100 and the separator 300 and is configured to uniformly distribute (move or discharge) the target fluid (e.g., water or hydrogen) while provided as a movement passage for electrons. The porous base layer 200 includes the porous base portion 210 provided between the membrane electrode assembly (MEA) and the separator 300, the channel areas CA defined on the porous base portion 210 to correspond to the channels 310, the land areas LA defined on the porous base portion 210 to correspond to the lands 320 and provided to be in contact with the lands 320, and the through-holes 220 provided in the land areas LA so that the target fluid may pass through the through-holes 220.

The porous base portion 210 may have various structures in accordance with required conditions and design specifications.

For example, the porous base portion 210 may be provided in a form of an approximately flat quadrangular plate corresponding to the separator 300.

The porous base portion 210 may be configured as a typical porous structure including pores. The present disclosure is not restricted or limited by the structure of the porous base portion 210 and the method of manufacturing the porous base portion 210.

For example, the porous base portion 210 may be provided to be similar in characteristics to a typical anode porous transport layer (PTL).

According to the exemplary embodiment of the present disclosure, the porous base portion 210 may be manufactured by forming base layer slurry SL containing metal elements into an approximately plate shape and then performing a heat treatment process (a degreasing process and a sintering process).

The channel area CA is defined on the porous base portion 210 to correspond to the channel 310.

In the exemplary embodiment of the present disclosure, the channel area CA may be understood as a region of the porous base portion 210 that faces the channel 310 of the separator 300. The target fluid flowing along the channel 310 may be supplied to the membrane electrode assembly 100 via the channel area CA.

For example, the channel area CA may be defined in a straight shape corresponding to the channel 310.

The land area LA is defined on the porous base portion 210 to correspond to the land 320.

In the exemplary embodiment of the present disclosure, the land area LA may be understood as a region of the porous base portion 210 that faces the land 320 of the separator 300 and is in direct contact with the land 320 of the separator 300.

For example, the land area LA may be defined in a straight shape corresponding to the land 320.

The through-hole 220 is provided in the land area LA so that the target fluid may pass through the through-hole 220. The through-holes 220 are provided to sufficiently ensure the transfer flow rate (transfer efficiency) of the target fluid, which is to be transferred to the membrane electrode assembly 100, even in the land area LA of the porous base layer 200 with which the land 320 is in contact.

This is to uniformly transfer the target fluid to the entire region of the membrane electrode assembly 100.

That is, the target fluid moving along the channel 310 may be diffused along the porous base layer 200 and then supplied to the membrane electrode assembly 100. However, a relatively smaller amount of target fluid is diffused in the land area LA of the porous base layer 200, which faces the land 320 of the separator 300, in comparison with the channel area CA of the porous base layer 200 that faces the channel 310 of the separator 300. For the present reason, there is a problem in that it is difficult to uniformly supply the target fluid to the entire region (entire region including the channel area CA and the land area LA) of the membrane electrode assembly.

However, according to the exemplary embodiment of the present disclosure, the through-holes 220 are provided in the land area LA of the porous base layer 200 so that the transmittance (porosity) of the land area LA may be increased. Therefore, it is possible to obtain an advantageous effect of minimizing the deterioration in transfer flow rate of the target fluid to be supplied to the region of the membrane electrode assembly 100 corresponding to the channel area CA and the region of the membrane electrode assembly 100 corresponding to the land area LA. Furthermore, it is possible to obtain an advantageous effect of minimizing the occurrence of a dead zone in which the target fluid cannot be supplied to the particular site of the membrane electrode assembly 100.

The through-hole 220 may have various structures and shapes in accordance with required conditions and design specifications. The present disclosure is not restricted or limited by the structure and shape of the through-hole 220.

According to the exemplary embodiment of the present disclosure, the through-hole 220 may be provided as a plurality of through-holes 220 provided in the land area LA and spaced from one another.

Hereinafter, an example will be described in which the plurality of through-holes 220 is provided in the land area LA and spaced from one another at predetermined intervals in a longitudinal direction LD and a width direction of the land 320.

According to another exemplary embodiment of the present disclosure, the plurality of through-holes may be provided in the land area and spaced from one another at irregular intervals. Alternatively, only a single through-hole may be provided in the land area.

Furthermore, the through-hole 220 may have various cross-sectional shapes such as a shape of a circle, a polygonal (e.g., quadrangular) shape, and an elliptical shape. The present disclosure is not restricted or limited by the cross-sectional shape of the through-hole 220. Hereinafter, an example will be described in which the through-hole 220 includes a circular cross-sectional shape.

According to the exemplary embodiment of the present disclosure, the porosity of the porous base layer 200 may increase in a direction from an inlet portion 225 of the channel 310 to an outlet portion 235 of the channel 310 in the longitudinal direction LD of the channel 310 (in a direction from the left side to the right side based on FIG. 7).

This is based on the fact that the transfer flow rate of the target fluid, which is to be transferred to the membrane electrode assembly 100 via the porous base layer 200, decreases toward a downstream side of the porous base layer 200 (the outlet portion of the channel). Because the porosity of the porous base layer 200 increases toward the downstream side of the porous base layer 200 (the outlet portion of the channel), it is possible to obtain an advantageous effect of more uniformly supplying the target fluid to the entire region of the membrane electrode assembly 100.

As described above, to increase the porosity at the downstream side of the porous base layer 200, the porosity of the land area LA of the porous base portion 210 may be gradually increased in the direction from the inlet portion (the left end portion based on FIG. 7) to the outlet portion (the right end portion based on the FIG. 7) of the channel 310 in the longitudinal direction LD of the channel 310.

According to the exemplary embodiment of the present disclosure, the through-holes 220 may include first through-holes 220a provided in the land area LA, and second through-holes 220b each including a size different from a size of the first through-hole 220a and spaced from the first through-holes 220a in the longitudinal direction LD of the channel 310.

In particular, the second through-holes 220b are provided at the downstream side from the first through-holes 220a in the longitudinal direction LD of the channel 310. The second through-hole 220b may be defined to include a relatively larger cross-sectional area (e.g., a larger diameter) than the first through-hole 220a.

More particularly, the plurality of through-holes 220 provided in the land area LA may each be defined to include a cross-sectional area that gradually increases in a direction from an inlet end portion to an outlet end portion of the channel 310 in the longitudinal direction LD of the channel 310. Therefore, the porosity of the porous base layer 200 may gradually increase in the direction from the inlet portion to the outlet portion of the channel 310 in the longitudinal direction LD of the channel 310.

According to the exemplary embodiment of the present disclosure, the porous base portion 210 may be defined to include a pore of 9 to 16 μm, and the through-hole 220 may be defined to include a diameter (or a length) of 20 to 50 μm.

That is, when the diameter of the through-hole 220 is smaller than 20 μm, there is a problem in that it is difficult to sufficiently ensure the transmittance (porosity) of the land area LA. In contrast, when the diameter of the through-hole 220 is greater than 50 μm, there is a problem in that it is difficult to sufficiently ensure the rigidity of the porous base layer 200.

Therefore, the through-hole 220 may be defined to include a diameter (or a length) of 20 to 50 μm under the condition in which the porous base portion 210 includes a pore of 9 to 16 μm. More particularly, the through-hole 220 may be defined to include a diameter (or a length) of 20 to 30 μm under the condition in which the porous base portion 210 includes a pore of 9 to 16 μm.

According to the exemplary embodiment of the present disclosure, the channel area CA may be defined to include a predetermined reference porosity, and the land area LA including the through-holes 220 may be defined to include a porosity of 120 to 200% of the reference porosity.

For example, the channel area CA may be defined to include a reference porosity of 30 to 40%, and the land area LA including the through-holes 220 may be defined to include a porosity of 120 to 200% of the reference porosity.

That is, if the porosity of the land area LA (the land area including the through-holes) is less than 120% of the porosity (reference porosity) of the channel area CA, there is a problem in that it is difficult to sufficiently ensure the transmittance (porosity) of the land area LA. In contrast, if the porosity of the land area LA (the land area including the through-holes) is more than 200% of the porosity (reference porosity) of the channel area CA, there is a problem in that it is difficult to sufficiently ensure the rigidity of the porous base layer 200.

Therefore, the channel area CA may be defined to include a reference porosity of 30 to 40%, and the land area LA including the through-holes 220 may be defined to include a porosity of 120 to 200% of the reference porosity. More particularly, the channel area CA may be defined to include a reference porosity of 30 to 40%, and the land area LA including the through-holes 220 may be defined to include a porosity of 120 to 150% of the reference porosity.

According to the exemplary embodiment of the present disclosure, the through-hole 220, which is provided at the downstream side of the land area LA (the downstream side of the land area LA corresponding to the outlet portion of the channel), may be defined to include a diameter (or a length) of 20 to 50 μm. More particularly, the through-hole 220, which is provided at the downstream side of the land area LA (the downstream side of the land area corresponding to the outlet portion of the channel), may be defined to include a diameter (or a length) of 20 to 30 μm.

According to the exemplary embodiment of the present disclosure, a section (region), in which the through-holes 220 are provided, may be defined as the land area LA corresponding to 20 to 50% of an overall length of the separator 300 based on the outlet end portion of the separator 300 (the outlet end portion of the channel). More particularly, the section (region), in which the through-holes 220 are provided, may be defined as the land area LA corresponding to 20 to 30% of the overall length of the separator 300 based on the outlet end portion of the separator 300 (the outlet end portion of the channel).

According to another exemplary embodiment of the present disclosure, the through-holes 220 may be provided in the entire section (region) instead of a partial section of the land area LA (see FIG. 9).

Meanwhile, the porous base layer 200 including the through-holes 220 may be manufactured in various ways in accordance with required conditions and design specifications. The present disclosure is not restricted or limited by the method of manufacturing the porous base layer 200.

For example, with reference to FIG. 3, the porous base layer 200 may be manufactured in a roll-to-roll manner by applying (inputting) base layer slurry SL onto one surface of a release sheet 500, thinning and flattening the base layer slurry SL by use of a doctor blade or the like, and then forming (pressing) the porous base portion 210, which is cured (solidified) by a dryer 510 (e.g., an infrared dryer), by use of a forming roller 400 including forming protrusions 410.

For reference, the release sheet 500 may be made of various materials in accordance with required conditions and design specifications. The present disclosure is not restricted or limited by the material and properties of the release sheet 500.

For example, the release sheet 500 may be provided by use of at least any one of polyethylene terephthalate (PET), polyethylene naphthalate (PEN), polycyclohexylene dimethylene terephthalate (PCT), low-density polyethylene (LDPE), linear low-density polyethylene (LLDPE), thermoplastic polyurethane (TPU), unstretched polypropylene (CPP), and polyvinylidene fluoride (PVDF).

Furthermore, the release sheet 500 may be configured as a single layer or configured by stacking a plurality of different layers.

The release sheet 500 may be wound around a first winding roller. A second winding roller may be configured to wind the release sheet 500 in a direction from one side to the other side along an open loop-shaped movement trajectory.

In the instant case, the configuration in which the release sheet 500 is wound in the direction from one side to the other side may be defined as a configuration in which the release sheet is moved (wound) along the open loop-type movement trajectory in a reel-to-reel winding manner, like a typical cassette tape.

One end portion of the release sheet 500 may be fixed to the first winding roller, and the other end portion of the release sheet 500 may be fixed to the second winding roller. When the first winding roller and the second winding roller rotate (e.g., clockwise), the release sheet 500 wound around the first winding roller may be wound around the second winding roller. The base layer slurry SL may be applied onto one surface of the release sheet 500 while the release sheet 500 is wound around the second winding roller from the first winding roller (e.g., wound at a speed of 0.3 to 1 m/min).

Furthermore, the release sheet 500 may be wound in a state in which a separate protective film is stacked on the release sheet 500 when the release sheet 500 is wound around the second winding roller.

The base layer slurry SL may be provided by mixing various materials in accordance with required conditions and design specifications. The present disclosure is not restricted or limited by the types of materials, which form the base layer slurry SL, and the composition ratios of the materials.

For example, the base layer slurry SL may be provided by mixing a metal element, a solvent, a dispersant, and a coupling agent.

At least one of a wire type metal element, a powder type metal element, and a mesh type metal element may be used as the metal element included in the base layer slurry SL.

For example, the metal element may include a titanium family element. More particularly, titanium family elements may include at least any one of titanium, zirconium, and hafnium.

According to another exemplary embodiment of the present disclosure, other metal elements such as nickel or stainless steel may be used, instead of the titanium family element, as the metal element.

Furthermore, the metal element (e.g., the titanium family element) may have various shapes configured for manufacturing the porous base layer 200. The present disclosure is not restricted or limited by the shape and structure of the metal element. For example, the metal element (e.g., the titanium family element) may be provided in a shape of a circle, an elliptical shape, an atypical shape, or a fiber shape.

In particular, the titanium family element may include an average particle size of 10 μm to 80 μm.

More particularly, an average particle size of the titanium family element may be 10 μm to 40 μm. If the average particle size of the titanium family element is smaller than 10 μm, there is a problem in that a porosity and pore size of the porous base layer 200 are too low, and brittleness is high. In contrast, if the average size of the titanium family element is greater than 40 μm, the porosity of the porous base layer 200 is too high, illuminance is high, and resistance in a water electrolysis stack increases, which may cause a problem of deterioration in performance. Therefore, the average particle size of the titanium family element may be defined to be 10 μm to 40 μm.

For reference, the average particle size of the titanium family element may be defined as a grain size of cumulative distribution 50% (D₅₀) in the grain size distribution measured by a particle size analyzer (PSA).

According to the exemplary embodiment of the present disclosure, the base layer slurry SL may include a titanium family element of 60 to 98 weight % with respect to the total weight of the base layer slurry SL.

If a titanium family element content is smaller than 60 weight % with respect to the total weight of the base layer slurry SL, a distance between the titanium family elements is long during a process of heat-treating the porous base layer 200 (a degreasing process and a sintering process), which may cause a problem in which the sintering process is not smoothly performed, the porosity of the porous base layer 200 is too high, and the rigidity is low. In contrast, if the titanium family element content is greater than 98 weight % with respect to the total weight of the base layer slurry SL, the porosity of the porous base layer 200 is too low, and the viscosity of the base layer slurry SL is too high, which causes a problem in which the porous base layer 200 cannot be normally manufactured.

Therefore, the titanium family element content may be defined to be 60 to 98 weight % with respect to the total weight of the base layer slurry SL. Particularly, the titanium family element content may be defined to be 65 to 85 weight % with respect to the total weight of the base layer slurry SL. More particularly, the titanium family element content may be defined to be 70 to 80 weight % with respect to the total weight of the base layer slurry SL.

Various solvents may be used as a solvent contained in the base layer slurry SL in accordance with required conditions and design specifications. The present disclosure is not restricted or limited by the type and properties of the solvent.

For example, ethanol, toluene, methanol, propanol, butanol, acetone, ketone, cyclohexenone, methyl acetate, ethyl acetate, and the like may be used as the solvent.

According to the exemplary embodiment of the present disclosure, the base layer slurry SL may include the solvent of 10 to 30 weight % with respect to the total weight of the base layer slurry SL.

If a solvent content is smaller than 10 weight % with respect to the total weight of the base layer slurry SL, the viscosity of the base layer slurry SL is high, and coating properties of a composition (base layer slurry) deteriorate. For the present reason, a thickness of the porous base layer 200 may not be uniform, the excessive deviation of porosity and pore sizes may occur for each position of the porous base layer 200. In contrast, if the solvent content is greater than 30 weight % with respect to the total weight of the base layer slurry SL, the solvent is excessively evaporated during a process of sintering the porous base layer 200, which may cause a problem in which the material and devices are contaminated, or it is difficult to satisfy a target thickness, a target porosity, and a target pore size.

Therefore, the solvent content may be defined to be 10 to 30 weight % with respect to the total weight of the base layer slurry SL. Particularly, the solvent content may be defined to be 15 to 30 weight % with respect to the total weight of the base layer slurry SL. More particularly, the solvent content may be defined to be 20 to 30 weight % with respect to the total weight of the base layer slurry SL.

Various dispersants may be used as a dispersant contained in the base layer slurry SL in accordance with required conditions and design specifications. The present disclosure is not restricted or limited by the type and properties of the dispersant.

For example, at least any one of water, ethanol, methanol, isopropanol, xylene, cyclohexanone, acetone, and methyl ethyl ketone may be used as the dispersant.

According to the exemplary embodiment of the present disclosure, the base layer slurry SL may include the dispersant of 0.1 to 3 weight % with respect to the total weight of the base layer slurry SL.

If a dispersant content is smaller than 0.1 weight % with respect to the total weight of the base layer slurry SL, there may occur a problem in which particles of the titanium family elements are aggregated during a process of manufacturing a composition (base layer slurry). In contrast, if the dispersant content is greater than 3 weight % with respect to the total weight of the base layer slurry SL, the viscosity of the composition (base layer slurry) is too low to perform a coating process, which may cause a problem in which workability is insufficient.

Therefore, the dispersant content may be defined to be 0.1 to 3 weight % with respect to the total weight of the base layer slurry SL. Particularly, the dispersant content may be defined to be 1 to 3 weight % with respect to the total weight of the base layer slurry SL. More particularly, the dispersant content may be defined to be 1.5 to 2.3 weight % with respect to the total weight of the base layer slurry SL.

Various coupling agents may be used as a coupling agent contained in the base layer slurry SL in accordance with required conditions and design specifications. The present disclosure is not restricted or limited by the type and properties of the dispersant.

For example, at least any one of polyvinyl butyral (PVB), polyvinyl alcohol (PVA), polyvinyl chloride (PVC), polyvinyl acetate (PVAc), and polyacrylonitrile may be used as the coupling agent.

According to the exemplary embodiment of the present disclosure, the base layer slurry SL may include the coupling agent of 0.1 to 5 weight % with respect to the total weight of the base layer slurry SL.

If a coupling agent content is smaller than 0.1 weight % with respect to the total weight of the base layer slurry SL, a binding force is insufficient between particles of the titanium family elements in the porous base layer 200, which may cause a problem in which the porous base layer 200 is hardly kept in a sheet shape. In contrast, if the coupling agent content is greater than 5 weight % with respect to the total weight of the base layer slurry SL, the binding force between the components in the composition (base layer slurry) is high, which may cause a problem in which the coupling agent attached to a lower substrate (e.g., the release sheet) during a coating process.

Therefore, the coupling agent content may be defined to be 0.1 to 4 weight % with respect to the total weight of the base layer slurry SL. Particularly, the coupling agent content may be defined to be 1 to 4 weight % with respect to the total weight of the base layer slurry SL. More particularly, the coupling agent content may be defined to be 2 to 3.5 weight % with respect to the total weight of the base layer slurry SL.

For reference, the base layer slurry SL may be manufactured by stirring (e.g., mixing in a ball mill process) the titanium family element, the solvent, the dispersant, and the coupling agent. For example, the stirring process may be performed by appropriately mixing zirconia balls with 5 to 30 mm with the base layer slurry SL. The stirring time of the base layer slurry SL may be 1 hour or more, 10 to 30 hours, or 18 to 24 hours. The composition (base layer slurry) with a viscosity of 1,000 to 8,000 cp may be manufactured by uniformly dispersing the mixture for 12 hours or more on average.

With reference to FIG. 3, FIG. 4, and FIG. 5, the forming roller 400 is configured to form the through-holes 220 in the porous base portion 210 provided by curing the base layer slurry.

For example, the forming roller 400 may be provided to be spaced from a support roller at a predetermined interval. The through-holes 220, which correspond to the forming protrusions 410, may be provided in the porous base portion 210 while the porous base portion 210 cured on the release sheet 500 passes between the forming roller 400 and the support roller.

The forming roller 400 may be configured to process the porous base portion 210 under a temperature condition of 110 to 140° C. and a load condition of 0.5 to 4 MPa (a load applied to the porous base portion).

The forming roller 400 may have various structures configured for forming the through-hole 220 in the porous base portion 210. The present disclosure is not restricted or limited by the structure of the forming roller 400.

For example, the forming roller 400 may include a roller body including an approximately cylindrical shape, and the plurality of forming protrusions 410 protruding from an external peripheral surface of the roller body.

For example, the plurality of forming protrusions 410 may be formed on the external peripheral surface of the roller body to correspond to the land area LA of the porous base portion 210. All the plurality of forming protrusions 410 may include the same size.

According to another exemplary embodiment of the present disclosure, the forming roller 400 may include the roller body including an approximately cylindrical shape, and the plurality of forming protrusions 410 protruding from the external peripheral surface of the roller body and including different sizes (e.g., diameters).

For example, the size (diameter) of the forming protrusion 410 provided on the external peripheral surface of the roller body may gradually increase in a direction from one end portion to the other end portion of the roller body in the longitudinal direction of the roller body.

For example, with reference to FIG. 6, the forming protrusions 410 may include a plurality of first forming protrusions 412 each including a first diameter, and a plurality of second forming protrusions 414 each including a second diameter greater than the first diameter and spaced from the first forming protrusions 412 in the longitudinal direction of the roller body.

Because the first forming protrusion 412 and the second forming protrusion 414 have different sizes as described above, the through-holes 220 (e.g., the first through-hole and the second through-hole) provided in the porous base portion 210 by the forming roller 400 may have different sizes (e.g., diameters).

For example, the first through-hole 220a and the second through-hole 220b, which includes a larger cross-sectional area (diameter) than the first through-hole 220a, may be provided in the porous base portion 210 by the forming roller 400 (see FIG. 8 and FIG. 9).

For reference, in FIG. 6, the example has been described in which the forming protrusions 410 are provided in a partial section (a portion of the external peripheral surface of the roller body) in the longitudinal direction of the roller body. However, according to another exemplary embodiment of the present disclosure, the forming protrusions may be provided in the entire section in the longitudinal direction of the roller body.

Meanwhile, in the exemplary embodiment of the present disclosure illustrated and described above, the example has been described in which the through-hole 220 is provided in the porous base portion 210 by pressing the porous base portion 210 with the forming roller 400. However, according to another exemplary embodiment of the present disclosure, the through-hole may be provided in the porous base portion by partially removing a portion of the porous base portion by a method such as machining or etching.

According to the exemplary embodiment of the present disclosure described above, it is possible to obtain an advantageous effect of ensuring the performance and operational efficiency and improving the durability and reliability.

According to the exemplary embodiment of the present disclosure, it is possible to obtain an advantageous effect of effectively diffusing the target fluid and uniformly supplying the target fluid to the entire region of the membrane electrode assembly.

Among other things, according to the exemplary embodiment of the present disclosure, it is possible to obtain an advantageous effect of effectively supplying the target fluid to the land area of the porous base layer provided to be in contact with the land of the separator.

Furthermore, according to the exemplary embodiment of the present disclosure, it is possible to obtain an advantageous effect of improving the transmittance of the porous base layer and improving the efficiency in moving the target fluid (performance in transmitting the target fluid).

Furthermore, according to the exemplary embodiment of the present disclosure, it is possible to obtain an advantageous effect of improving the stability, reliability, and durability.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A porous base layer comprising:
a porous base portion provided between a membrane electrode assembly (MEA) and a separator including a channel and a land;
a channel area defined on the porous base portion to correspond to the channel;
a land area defined on the porous base portion to correspond to the land and provided to be in contact with the land; and
at least one through-hole provided in the land area so that a target fluid passes through the at least one through-hole.

2. The porous base layer of claim 1, wherein a porosity of the land area increases in a direction from an inlet portion to an outlet portion of the channel in a longitudinal direction of the channel.

3. The porous base layer of claim 1, wherein the at least one through-hole is in plural and the plurality of through-holes is defined to include a cross-sectional area different from adjacent through-holes in a longitudinal direction of the channel.

4. The porous base layer of claim 3, wherein the plurality of through-holes include:
a first through-hole; and
a second through-hole defined to include a size different from a size of the first through-hole and spaced from the first through-hole in the longitudinal direction of the channel.

5. The porous base layer of claim 1, wherein the at least one through-hole is in plural and the plurality of through-holes is defined to include a cross-sectional area that increases in a direction from an inlet end portion to an outlet end portion of the channel in a longitudinal direction of the channel.

6. The porous base layer of claim 5, wherein the at least one through-hole include:
a first through-hole; and
a second through-hole provided at a downstream side from the first through-hole in the longitudinal direction of the channel and defined to include a relatively larger cross-sectional area than the first through-hole.

7. The porous base layer of claim 1, wherein the porous base portion is defined to include a pore of 9 to 16 μm.

8. The porous base layer of claim 1, wherein the at least one through-hole is defined to include a diameter of 20 to 50 μm.

9. The porous base layer of claim 1, wherein the channel area is defined to include a predetermined reference porosity, and the land area including the at least one through-hole is defined to include a porosity of 120 to 200% of the reference porosity.

10. An electrochemical apparatus comprising:
a membrane electrode assembly (MEA);
a separator including a channel and a land provided on one surface facing the membrane electrode assembly, the separator being stacked on the membrane electrode assembly; and
a porous base layer provided between the separator and the membrane electrode assembly,
wherein the porous base layer includes:
a porous base portion provided between the separator and the membrane electrode assembly (MEA);
a channel area defined on the porous base portion to correspond to the channel;
a land area defined on the porous base portion to correspond to the land and provided to be in contact with the land; and
at least one through-hole provided in the land area so that a target fluid passes through the at least one through-hole.

11. The electrochemical apparatus of claim 10, wherein a porosity of the land area increases in a direction from an inlet portion to an outlet portion of the channel in a longitudinal direction of the channel.

12. The electrochemical apparatus of claim 10, wherein the at least one through-hole is in plural and the plurality of through-holes is defined to include a cross-sectional area different from adjacent through-holes in a longitudinal direction of the channel.

13. The electrochemical apparatus of claim 12, wherein the plurality of through-holes include:
a first through-hole; and
a second through-hole defined to include a size different from a size of the first through-hole and spaced from the first through-hole in the longitudinal direction of the channel.

14. The electrochemical apparatus of claim 10, wherein the at least one through-hole is in plural and the plurality of through-holes is defined to include a cross-sectional area that increases in a direction from an inlet end portion to an outlet end portion of the channel in a longitudinal direction of the channel.

15. The electrochemical apparatus of claim 14, wherein the plurality of through-holes include:
a first through-hole; and
a second through-hole provided at a downstream side from the first through-hole in the longitudinal direction of the channel and defined to include a relatively larger cross-sectional area than the first through-hole.

16. The electrochemical apparatus of claim 10, wherein the porous base portion is defined to include a pore of 9 to 16 μm.

17. The electrochemical apparatus of claim 10, wherein the through-hole is defined to include a diameter of 20 to 50 μm.

18. The electrochemical apparatus of claim 10, wherein the channel area is defined to include a predetermined reference porosity, and the land area including the through-hole is defined to include a porosity of 120 to 200% of the reference porosity.
